(19) United States
(12) Patent Application Publication
(10) Pub. No.: US 2025/0311022 A1
(43) Pub. Date: Oct. 2, 2025

(54) INFORMATION ACQUISITION METHOD AND APPARATUS, BLUETOOTH DEVICE, TERMINAL DEVICE, AND STORAGE MEDIUM

(71) Applicant: GUANGDONG OPPO MOBILE TELECOMMUNICATIONS CORP., LTD., Dongguan (CN)

(72) Inventor: Ruitian HOU, Dongguan (CN)

(73) Assignee: GUANGDONG OPPO MOBILE TELECOMMUNICATIONS CORP., LTD., Dongguan (CN)

(21) Appl. No.: 19/181,922

(22) Filed: Apr. 17, 2025

Related U.S. Application Data
(63) Continuation of application No. PCT/CN2023/119904, filed on Sep. 20, 2023.

(30) Foreign Application Priority Data
Oct. 21, 2022 (CN) 202211295568.1

(51) Int. Cl. H04W 76/10; H04L 41/50; H04W 76/40

(52) U.S. Cl. CPC H04W 76/10; H04L 41/5058; H04W 76/40

(57) ABSTRACT

An information acquisition method a Bluetooth device, and a terminal device. The method is applied to a Bluetooth device; and includes: obtaining first information; wherein the first information comprises Generic Attribute Profile (GATT) information of the Bluetooth devices; and sending the first information to a terminal device to enable the terminal device to obtain the GATT information based on the first information, before the Bluetooth device and the terminal device complete a Bluetooth Low Energy (BLE) connection.

### CROSS-REFERENCE TO RELATED APPLICATIONS

The present application is a continuation-application of International (PCT) Patent Application No. PCT/CN2023/119904, filed on Sep. 20, 2023, which claims priority of Chinese Patent Application No. 202211295568.1, filed on Oct. 21, 2022, the entire contents of which are hereby incorporated by reference in their entirety.

### TECHNICAL FIELD

The present disclosure relates to the field of Bluetooth connection technologies, and in particular to an information acquisition method, an apparatus, a Bluetooth device, a terminal device, and a storage medium.

### BACKGROUND

With the advancement of Bluetooth technology, wireless data transmission between terminal devices via Bluetooth has become ubiquitous in daily life.

As the next-generation Bluetooth audio transmission technology, Low Energy Audio (LE-Audio) offers significant advantages including reduced power consumption, lower implementation costs, enhanced audio quality, and minimized latency for wireless audio services. During the establishment of LE-Audio connections, it is required that a Bluetooth Low Energy (BLE) link is first established, and Generic Attribute Profile (GATT) information is retrieved from the Bluetooth headset. This multi-stage process is inherently time-consuming, resulting in suboptimal connection efficiency for terminal device Bluetooth pairing.

### SUMMARY OF THE DISCLOSURE

The present disclosure provides an information acquisition method a Bluetooth device, and a terminal device.

In a first aspect, the present disclosure provides an information acquisition method, performed by a Bluetooth device and including:
obtaining first information; wherein the first information includes Generic Attribute Profile (GATT) information of the Bluetooth device; and
sending the first information to a terminal device to enable the terminal device to obtain the GATT information based on the first information, before the Bluetooth device and the terminal device complete a Bluetooth Low Energy (BLE) connection.

In a second aspect, the present disclosure provides an information acquisition method, performed by a terminal device and including:
receiving first information sent by a Bluetooth device before the terminal device and the Bluetooth device complete a Bluetooth Low Energy (BLE) connection; wherein the first information includes Generic Attribute Profile (GATT) information of the Bluetooth device; and
obtaining the GATT information based on the first information.

In a third aspect, the present disclosure provides a Bluetooth device, including a processor and a memory; wherein the memory stores one kind of: at least one instruction, at least one program, a code set, and an instruction set, and the one kind of the at least one instruction, the at least one program, the code set, and the instruction set is configured to be loaded and executed by the processor to implement the method as above.

In a fourth aspect, the present disclosure provides a terminal device, including a processor and a memory; wherein the memory stores one kind of: at least one instruction, at least one program, a code set, and an instruction set, and the one kind of the at least one instruction, the at least one program, the code set, and the instruction set is configured to be loaded and executed by the processor to implement the method as above.

### BRIEF DESCRIPTION OF THE DRAWINGS

In order to more clearly illustrate the technical solution in the embodiments of the present disclosure, the following is a brief description of the drawings needed to be used in the description of the embodiments. Obviously, the drawings in the following description are only some embodiments of the present disclosure, and other drawings may be obtained based on these drawings.

FIG. 1 is a flowchart of a Bluetooth connection between a terminal device and a Bluetooth headset according to some embodiments of the present disclosure.

FIG. 2 is a structural diagram of broadcast information according to some embodiments of the present disclosure.

FIG. 3 is a structural diagram of GATT information according to some embodiments of the present disclosure.

FIG. 4 is a structural diagram of a terminal device according to some embodiments of the present disclosure.

FIG. 5 is a flowchart of an information acquisition method according to some embodiments of the present disclosure.

FIG. 6 is a flowchart of an information acquisition method according to some embodiments of the present disclosure.

FIG. 7 is a flowchart of an information acquisition method according to some embodiments of the present disclosure.

FIG. 8 is a flowchart of an information acquisition method according to some embodiments of the present disclosure.

FIG. 9 is a flowchart of an information acquisition method according to some embodiments of the present disclosure.

FIG. 10 is a structural block diagram of an information acquisition apparatus according to some embodiments of the present disclosure.

FIG. 11 is a structural block diagram of an information acquisition apparatus according to some embodiments of the present disclosure.

FIG. 12 is a structural diagram of a Bluetooth device according to some embodiments of the present disclosure.

### DETAILED DESCRIPTION

The following will provide a detailed description of the exemplary embodiments, which are illustrated in the accompanying drawings. When the following description refers to the drawings, unless otherwise indicated, the same reference numerals denote the same or similar elements in different drawings. The embodiments described in the following exemplary embodiments do not represent all embodiments consistent with the present disclosure. Rather, they are merely examples of apparatuses and methods consistent with some aspects of the present disclosure as detailed in the appended claims.

Bluetooth technology is a wireless radio technology that enables short-range communication between devices, allowing wireless information exchange between multiple electronic devices that support Bluetooth transmission, thereby making data transmission between electronic devices faster and more efficient. It should be noted that the term “multiple” as used herein refers to two or more, and the term “multiple types” is used analogously.

With the advancement of Bluetooth technology, wireless data transmission between terminal devices via Bluetooth has become ubiquitous in daily life. For example, after establishing a Bluetooth connection between a terminal device and a Bluetooth headset, users can play audio data through the Bluetooth headset to achieve data interaction. As the next-generation Bluetooth audio transmission technology, Low Energy Audio (LE-Audio) offers significant advantages including reduced power consumption, lower implementation costs, enhanced audio quality, and minimized latency for wireless audio services.

In some embodiments, the Bluetooth device may be a wireless Bluetooth headset, such as a True Wireless Stereo (TWS) Bluetooth headset, etc., and the terminal device may include, but is not limited to, wearable devices (such as smart bracelets, smart watches, smart glasses, etc.), mobile phones, tablet computers, laptops, Moving Picture Experts Group Audio Layer III (MP3) players, Moving Picture Experts Group Audio Layer IV (MP4) players, desktop computers, laptop computers, smart home devices, and other terminal devices with Bluetooth connectivity. In this context, the Bluetooth devices may function as terminal devices, and the terminal device may function as Bluetooth devices.

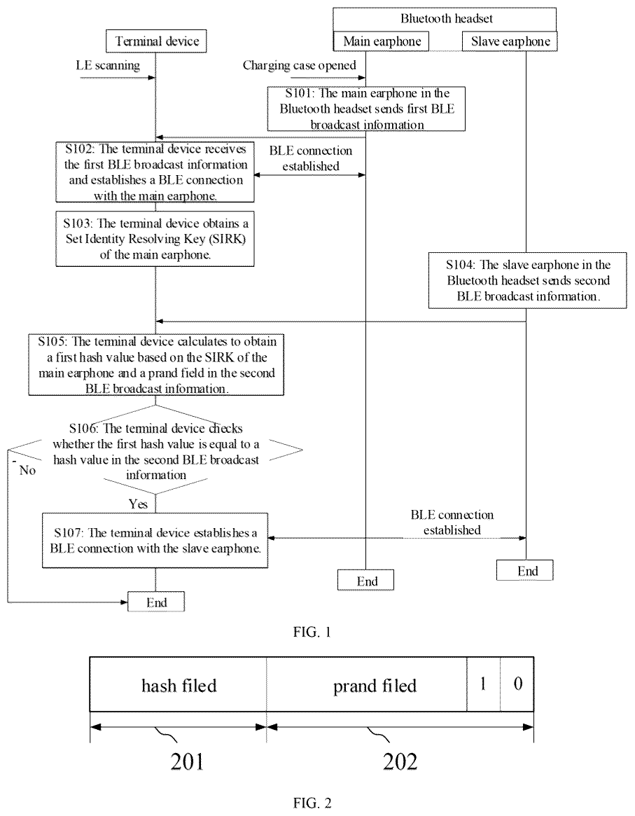

Referring to FIG. 1, FIG. 1 is a flowchart of a Bluetooth connection between a terminal device and a Bluetooth headset according to some embodiments of the present disclosure. As shown in FIG. 1, the Bluetooth connection process may include operations at blocks illustrated herein.

At block 101: A main earphone in the Bluetooth headset sends first BLE broadcast information.

The Bluetooth headset, as a Bluetooth device, can actively broadcast the first BLE broadcast information into the surrounding space, enabling another terminal device to receive the information and establish a Bluetooth connection with the Bluetooth headset. In practical applications, the Bluetooth headset is typically placed in a charging case, and a user can activate the headset by opening the charging case, causing the headset to begin broadcasting the first BLE broadcast information into the surrounding space. In some embodiments, left and right earphones of the Bluetooth headset can simultaneously broadcast BLE signals, which are configured to trigger the establishment of a Low Energy (LE) Audio Bluetooth connection. Alternatively, when either of the left or right earphones is active, it can broadcast BLE signals to trigger the establishment of a LE Audio Bluetooth connection. In the embodiments, taking a TWS headset as an example, the main earphone can first actively broadcast the first BLE broadcast information into the surrounding space.

At block 102: The terminal device receives the first BLE broadcast information and establishes a BLE connection with the main earphone.

In some embodiments, the terminal device may enable its own Bluetooth functionality and perform a LE scan to scan for the first BLE broadcast information in the surrounding space. After obtaining the first BLE broadcast information, the terminal device may establish a BLE connection with the main earphone in the Bluetooth headset.

At block 103: The terminal device obtains a Set Identity Resolving Key (SIRK) of the main earphone.

In some embodiments, the Bluetooth LE Audio technology provides a Coordinated Set Identification Service (CSIS) protocol, which allows devices belonging to the same set to achieve coordinated synchronization when interacting with external devices. The CSIS protocol primarily specifies how an external device (equivalent to the terminal device in the present embodiments) identifies multiple independent Bluetooth devices (equivalent to the Bluetooth main earphone and slave earphone in the present embodiments) within a single group as belonging to the same set. For multiple devices belonging to the same set, when they are to be used simultaneously with an external device, each device must establish an independent LE Audio Bluetooth connection with the external device. Additionally, based on the obtained SIRK of each device, devices with the same SIRK value can be grouped into a single set. Therefore, after the terminal device establishes a BLE connection with the main earphone in the Bluetooth headset, the terminal device can obtain the SIRK of the main earphone.

At block 104: A slave earphone in the Bluetooth headset sends second BLE broadcast information.

In some embodiments, the slave earphone in the Bluetooth headset may send second BLE broadcast information.

At block 105: The terminal device calculates to obtain a first hash value based on the SIRK of the main earphone and a prand field in the second BLE broadcast information.

Correspondingly, the terminal device may receive the second BLE broadcast information sent by the slave earphone and obtain the prand field from the second BLE broadcast information. Referring to FIG. 2, FIG. 2 is a structural diagram of broadcast information according to some embodiments of the present disclosure. As shown in FIG. 2, a hash field 201 and a prand field 202 are included. The terminal device may obtain the prand field from the second BLE broadcast through parsing, and calculate the first hash value in combination with the SIRK of the main earphone.

At block 106: The terminal device checks whether the first hash value is equal to a hash value in the second BLE broadcast information.

In some embodiments, after obtaining the first hash value, the terminal device determines whether the first hash value is equal to the hash value in the second BLE broadcast information to determine whether the slave earphone belongs to a same coordination set as the main earphone.

In other words, in the embodiments, for a Bluetooth headset supporting Bluetooth LE Audio planned to be connected for the first time, both earphones of the Bluetooth headset may send their own LE Audio broadcasts when the charging case is opened. When the user selects one of the earphones (the main earphone) to connect, the mobile phone (terminal device) first establishes a BLE connection with the main earphone and obtains its SIRK. In this case, the main earphone can function normally with the terminal device. When the terminal device receives the BLE broadcast information from the slave earphone, it analyses whether the slave earphone belongs to the same coordination set as the currently connected main earphone. Based on the SIRK of the main earphone and the prand field in the second BLE broadcast information from the slave earphone, the terminal device calculates to obtain the first hash value and detects whether it is equal to the hash value in the second BLE broadcast information from the slave earphone. When the both hash values are equal, the terminal device automatically establishes a LE Audio connection with the slave earphone and operates normally. When the both hash values are not equal, it indicates that the main earphone and the slave earphone do not belong to the same coordination set, i.e., not a same group, in which case the Bluetooth connection process is terminated.

At block 107: When the first hash value is equal to the hash value in the second BLE broadcast information from the slave earphone, the terminal device establishes a BLE connection with the slave earphone.

When the terminal device detects that the first hash value is equal to the hash value in the second BLE broadcast information, the terminal device establishes a BLE connection with the slave earphone, completing the process of establishing BLE connections with both the main earphone and the slave earphone in the Bluetooth headset.

In some embodiments, after establishing the BLE connections, the terminal device may further obtain Generic Attribute Profile (GATT) information of the Bluetooth headset (e.g., through a GATT service discovery process) to determine functions supported by the Bluetooth headset (e.g., touch pause), thereby completing the overall LE Audio configuration and enabling normal use of these functions.

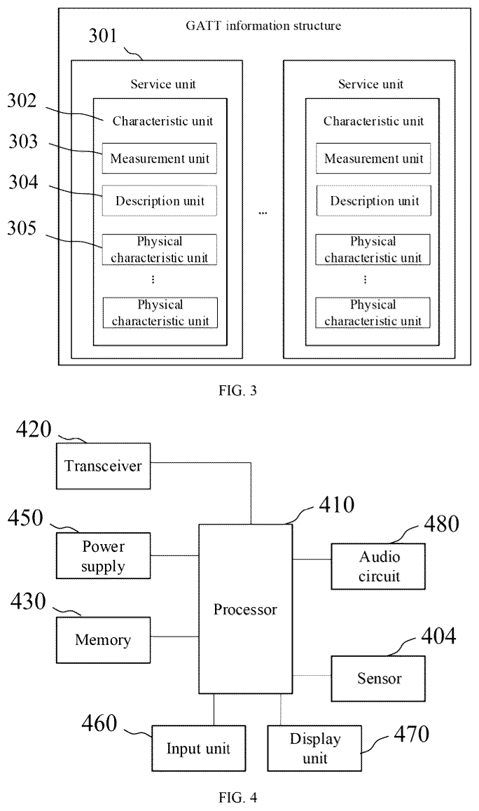

Referring to FIG. 3, FIG. 3 is a structural diagram of GATT information according to some embodiments of the present disclosure. For example, the GATT information structure may include one or more of the following units: a service unit 301, a characteristic unit 302, a measurement unit 303, a description unit 304, and a physical characteristic unit 305. As illustrated in FIG. 3, the GATT information structure includes the aforementioned units. Among these, the service unit 301 may be represented by the service field, the characteristic unit 302 may be represented by the characteristic field, the measurement unit 303 may be represented by the value field, the description unit 304 may be represented by the descriptor field, and the physical characteristic unit 305 may be represented by the Properties field. In some embodiments, each of the above units may have a separate handle identifier, and the terminal device is required to query them separately via the Attribute Profile (ATT). Therefore, the GATT information may include one or more management handle identifiers corresponding to the information units; in some embodiments, the GATT information may further include other content of the above GATT information structure. When a Bluetooth device has a large amount of GATT information, the terminal device is further required to allocate a significant amount of time for ATT queries, resulting in low efficiency in obtaining GATT information.

In the process shown in FIG. 1, a BLE connection is established between the Bluetooth headset and the terminal device based on LE-Audio technology. After the BLE connection is established, the terminal device and the Bluetooth headset interact to allow the terminal device to query the Bluetooth headset's GATT information (e.g., through a GATT service discovery process) and complete the subsequent configuration of LE-Audio technology (e.g., related LE Audio profile configuration), which may be understood as establishing a LE Audio Bluetooth connection based on the LE Audio protocol, thereby enabling the normal use of the functions provided by the Bluetooth headset. The functions may be understood to include audio transmission over the LE Audio Bluetooth connection. In some embodiments, the audio transmission over the LE Audio Bluetooth connection may involve establishing a Connected Isochronous Stream (CIS) data stream channel for further connection when there is a need for audio transmission, thereby enabling the audio data transmission. In some embodiments, some or all of the operations involved in establishing a BLE connection or a LE Audio Bluetooth connection may refer to the relevant provisions of the LE Audio Bluetooth standard. Since GATT information is typically extensive, the terminal device must query each item individually, which consumes a significant amount of time and results in low efficiency when obtaining the GATT information, thereby leading to low efficiency in Bluetooth connections for terminal devices.

Referring to FIG. 4, FIG. 4 is a structural diagram of a terminal device according to some embodiments of the present disclosure. As shown in FIG. 4, the terminal device includes a processor 410, a transceiver 420, and a display unit 470. The display unit 470 may include a display screen.

In some embodiments, the terminal device may further include a memory 430. The processor 410, the transceiver 420, and the memory 430 may communicate with each other via internal connection pathways to transmit ranging data. The memory 430 is configured to store computer programs, and the processor 410 is configured to call and execute the computer programs from the memory 430.

The processor 410 may be integrated with the memory 430 to form a processing unit, or more commonly, they may be independent components. The processor 410 is configured to execute the program code stored in the memory 430 to perform the aforementioned functions. In a specific implementation, the memory 430 may be integrated into the processor 410 or may be independent of the processor 410.

It should be understood that the terminal device shown in FIG. 4 may include one or more processing units. For example, the processor 410 may include an application processor (AP), a modem processor, a graphics processing unit (GPU), an image signal processor (ISP), a controller, a video codec, a digital signal processor (DSP), a baseband processor, and/or a neural-network processing unit (NPU). The different processing units may be independent devices or integrated into one or more processors.

The processor 410 may further include a memory for storing instructions and data. In some embodiments, the memory in the processor 410 is a high-speed cache memory. The memory can store instructions or data that the processor 410 has recently used or is reusing. If the processor 410 needs to use the instruction or data again, it can be directly retrieved from the memory, which may avoid repeated accesses, reducing the waiting time of the processor 410, thereby improving system efficiency.

In some embodiments, the processor 410 may include one or more interfaces. The interfaces may include an inter-integrated circuit (14C) interface, an inter-integrated circuit sound (14S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, and/or a universal serial bus (USB) interface.

The UART interface is a general-purpose serial data bus used for asynchronous communication. This bus may function as a bidirectional communication bus, which converts data to be transmitted between serial and parallel communication formats. In some implementations, the UART interface is typically configured to connect the processor 410 to the transceiver 420. For example, the processor 410 communicates with a Bluetooth module in the transceiver 420 via the UART interface to enable Bluetooth functionality.

The MIPI interface may be configured to connect the processor 410 to peripheral devices such as the display unit 470. The MIPI interface includes a camera serial interface (CSI) and a display serial interface (DSI). In some embodiments, the processor 410 and the display unit 470 communicate via the DSI interface to implement the display function of the terminal device.

The GPIO interface may be configured via software. The GPIO interface may be configured as a control signal or as a data signal. In some embodiments, the GPIO interface may be configured to connect the processor 410 to the display unit 470, the transceiver 420, and other components. The GPIO interface may be configured as an 14C interface, an 14S interface, a UART interface, a MIPI interface, etc.

The transceiver 420 may provide wireless communication solutions for terminal devices, including wireless local area networks (WLAN) (e.g., wireless fidelity (Wi-Fi) networks), Bluetooth (BT), global navigation satellite systems (GNSS), frequency modulation (FM), near field communication (NFC), infrared (IR), IR), etc. The transceiver 420 may be one or more devices integrated with at least one communication processing module, such as a Bluetooth module.

The memory 430 may be configured to store computer-executable program code, which includes instructions. The memory 430 may include a program storage area and a data storage area. The program storage area can store an operating system, at least one application required for a function (such as sound playback, image playback, etc.), etc. The data storage area can store data created during the use of the terminal device (such as location data), etc. Additionally, the memory 430 may include high-speed random-access memory and/or non-volatile memory, such as at least one disk storage device, flash memory device, or universal flash storage (UFS). The processor 410 executes various functional applications and data processing of the terminal device by running instructions stored in the memory 430 and/or instructions stored in the memory within the processor.

Furthermore, to enhance the functionality of the terminal device, the terminal device may further include one or more of the following components: a power supply 450, an input unit 460, an audio circuit 480, and a sensor 404.

The power supply 450 provides power to various devices or circuits within the terminal device. In some embodiments, the power supply 450 is logically connected to the processor 410 via a power management device, thereby enabling the power management device to manage functions such as charging, discharging, and power consumption management.

The input unit 460 is configured to receive input digital or character information and generate key signals related to the user settings and functional control of the terminal device. Specifically, the input unit 460 may include a touch panel and other input devices. The touch panel, also known as a touchscreen, collects touch operations performed by the user on or near it, such as operations using fingers, styluses, or any other suitable objects or accessories on or near the touch panel, and drives the corresponding connected devices according to predefined programs. In some embodiments, the touch panel may include two parts: a touch detection device and a touch controller. The touch detection device detects the user's touch location and the signals generated by the touch operation, and transmits these signals to the touch controller. The touch controller receives the touch information from the touch detection device, converts it into touch point coordinates, and sends them to the processor 410. The touch controller may further receive commands from the processor 410 and execute them accordingly. Additionally, the touch panel may be implemented using various types such as resistive, capacitive, infrared, or surface acoustic wave. In addition to the touch panel, the input unit 460 may include other input devices. Specifically, the other input devices may include, but are not limited to, one or more of the following: a function key, a trackball, or a joystick.

The display unit 470 is configured to display information input by the user or information provided to the user, as well as various menus of the terminal device. The display unit 470 may include a display panel, which may be implemented by a liquid crystal display (LCD) or an organic light-emitting diode (OLED). Furthermore, a touch panel may cover the display panel. When the touch panel detects a touch operation on or near it, it transmits the information to the processor 410 to determine the type of touch event. Subsequently, the processor 410 provides corresponding visual output on the display panel based on the type of touch event.

The terminal device may further include at least one sensor 404, such as a gyroscope sensor, a motion sensor, and other sensors. Specifically, the gyroscope sensor may be configured to determine a motion posture of the terminal device. In some embodiments, the angular velocity of the terminal device around three axes (i.e., the x, y, and z axes) may be determined via the gyroscope sensor. The gyroscope sensor may further be applied for navigation and motion-based gaming scenarios. As a type of the motion sensor, an accelerometer can detect the magnitude of acceleration in various directions (i.e., the x, y, and z axes) and, when stationary, can detect the magnitude and direction of gravity, which may be applied for applications that identify the orientation of the terminal device (e.g., screen orientation switching, related games, magnetometer orientation calibration), vibration recognition-related functions (e.g., pedometer, tapping), etc. As for other sensors that can be configured on the terminal device, such as a pressure sensor, a barometer, a humidity sensor, a temperature sensor, and an infrared sensor, which will not be elaborated upon herein.

The audio circuit 480 may include a speaker and a microphone, providing an audio interface between the user and the terminal device. The audio circuit 480 converts the received audio data into electrical signals and transmits them to the speaker, which converts them into sound signals for output. On the other hand, the microphone converts the collected sound signals into electrical signals, which are received by the audio circuit 480 and converted into audio data. The audio data is then output to the processor 410 for processing, and after being transmitted via the RF circuit, it is sent to another terminal device, or the audio data is output to the memory 430 for further processing.

It should be understood that the structure illustrated in the embodiments of the present disclosure does not constitute a specific limitation on the terminal device. In other embodiments of the present disclosure, the terminal device may include more or fewer components than those illustrated, or may combine certain components, split certain components, or arrange components differently. The components shown in the drawings may be implemented as hardware, software, or a combination of software and hardware.

Additionally, the terminal device involved in the embodiments of the present disclosure may be equipped with an operating system, on which applications may be installed and run, such as the Android system, iOS system, Linux system, etc. The embodiments of the present disclosure do not limit this.

To address the issues in the related art and improve the efficiency of terminal devices in obtaining GATT information, the present disclosure provides an information acquisition method. Before the Bluetooth device and the terminal device complete the Bluetooth Low Energy (BLE) connection, the first information containing GATT information is proactively sent to the terminal device in advance, thereby eliminating the need for the terminal device to subsequently perform ATT queries or similar processes.

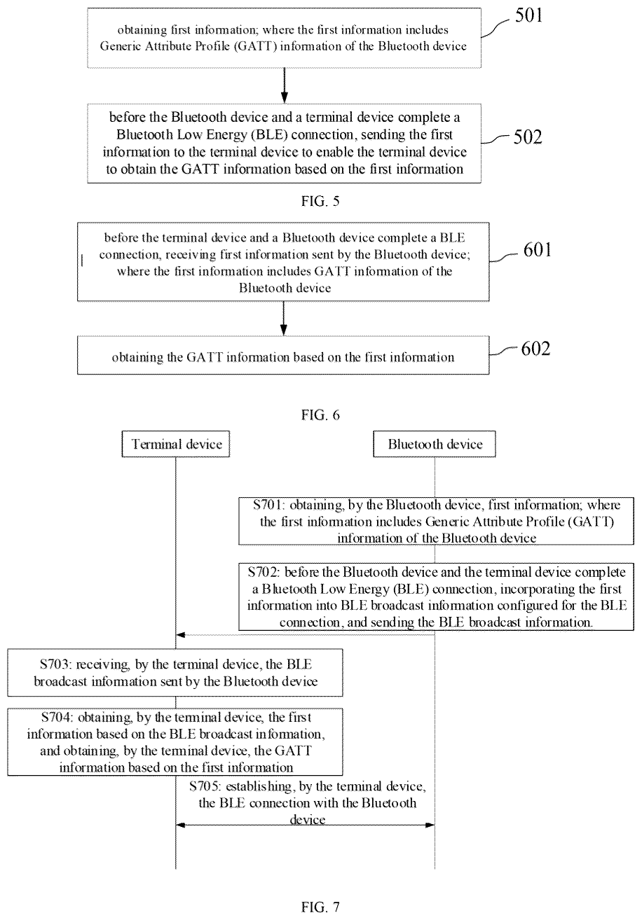

Referring to FIG. 5, FIG. 5 is a flowchart of an information acquisition method according to some embodiments of the present disclosure. The information acquisition method may be performed by a Bluetooth device. As shown in FIG. 5, the information acquisition method may include operations at blocks illustrated herein.

At block 501: obtaining first information; where the first information includes Generic Attribute Profile (GATT) information of the Bluetooth device.

In some embodiments, the Bluetooth device is required to send the GATT information to the terminal device before completing the Bluetooth low energy (BLE) connection with the terminal device, allowing the Bluetooth device to obtain its own GATT information in advance. In some embodiments, the first information may only include the GATT information (equivalent to the first information being the GATT information) or may include other information in addition to the GATT information. The other information may be information that the terminal device needs to obtain after the Bluetooth device and the terminal device complete the BLE connection. For example, when the terminal device further needs to obtain information A of the Bluetooth device, the first information may include the GATT information and the information A.

At block 502: before the Bluetooth device and a terminal device complete a Bluetooth Low Energy (BLE) connection, sending the first information to the terminal device to enable the terminal device to obtain the GATT information based on the first information.

In some embodiments, the Bluetooth device may send the first information to the terminal device before the Bluetooth device and the terminal device establish the BLE connection. In some embodiments, the Bluetooth device may send the first information, carried in information required to be exchanged with the terminal device (e.g., broadcast information), to the terminal device. It should be noted that when the Bluetooth device is a Bluetooth headset, both the main earphone and the slave earphone of the Bluetooth headset may be considered as separate Bluetooth devices. For example, in the above FIG. 1, the so-called “before the Bluetooth device and a terminal device complete a Bluetooth Low Energy (BLE) connection” is equivalent to before operation 102 or before operation 107.

In summary, the Bluetooth device obtains the first information, which includes the Bluetooth device's GATT information; before the Bluetooth device and the terminal device complete the BLE connection, the first information is sent to the terminal device such that the terminal device can obtain the GATT information based on the first information. In the present disclosure, by proactively sending the first information containing the GATT information to the terminal device before the Bluetooth device and the terminal device complete the BLE connection, the terminal device can obtain the GATT information of the Bluetooth device in advance based on the first information. After the BLE connection is established, there is no need to query the GATT information separately, thereby reducing the time required for the terminal device to obtain the GATT information and thus improving the efficiency of the terminal device in obtaining the GATT information, and further enhancing the efficiency of establishing the Bluetooth connection between the terminal device and the Bluetooth device.

Correspondingly, referring to FIG. 6, FIG. 6 is a flowchart of an information acquisition method according to some embodiments of the present disclosure. The method may be performed by a terminal device. As shown in FIG. 6, the information acquisition method may include operations at blocks illustrated herein.

At block 601: before the terminal device and a Bluetooth device complete a Bluetooth Low Energy (BLE) connection, receiving first information sent by the Bluetooth device; where the first information includes Generic Attribute Profile (GATT) information of the Bluetooth device.

In some embodiments, the first information may be included in information carried in information required to be exchanged with the terminal device (e.g., broadcast information). The terminal device may obtain the first information by parsing the information after receiving the information. In some embodiments, the first information may include only the GATT information (equivalent to the first information being the GATT information) or include other information in addition to the GATT information. The other information may be information that the terminal device needs to obtain after the Bluetooth device and the terminal device complete the BLE connection. For example, when the terminal device further needs to obtain information A of the Bluetooth device, the first information may include the GATT information and the information A.

At block 602: obtaining the GATT information based on the first information.

In some embodiments, the terminal device may obtain the GATT information based on the first information.

In summary, the Bluetooth device obtains the first information, which includes the Bluetooth device's GATT information; before the Bluetooth device and the terminal device complete the BLE connection, the first information is sent to the terminal device such that the terminal device can obtain the GATT information based on the first information. In the present disclosure, by proactively sending the first information containing the GATT information to the terminal device before the Bluetooth device and the terminal device complete the BLE connection, the terminal device can obtain the GATT information of the Bluetooth device in advance based on the first information. After the BLE connection is established, there is no need to query the GATT information separately, thereby reducing the time required for the terminal device to obtain the GATT information and thus improving the efficiency of the terminal device in obtaining the GATT information, and further enhancing the efficiency of establishing the Bluetooth connection between the terminal device and the Bluetooth device.

The interaction between the terminal device and the Bluetooth device for establishing the Bluetooth connection is illustrated to introduce the scheme shown in FIGS. 5 and 6.

Referring to FIG. 7, FIG. 5 is a flowchart of an information acquisition method according to some embodiments of the present disclosure. The information acquisition method may be performed by a Bluetooth device and a terminal device. As shown in FIG. 7, the information acquisition method may include operations at blocks illustrated herein.

At block 701: obtaining, by the Bluetooth device, first information; where the first information includes Generic Attribute Profile (GATT) information of the Bluetooth device.

In some embodiments, the Bluetooth device may obtain the GATT information to be sent to the terminal device and take the GATT information as the first information. Alternatively, the Bluetooth device may obtain the GATT information and other information to be sent to the terminal device and package the GATT information and other information into a single packet, to obtain the first information containing the GATT information.

In some embodiments, the GATT information includes one or more management handle identifiers corresponding to information units. For example, for the GATT information structure shown in FIG. 3, the management handle identifiers corresponding to each information unit in the GATT information obtained by the Bluetooth device are required to be queried by the terminal device via ATT. Therefore, the GATT information obtained herein may include the management handle identifiers corresponding to each information unit, which are then sent to the terminal device.

At block 702: before the Bluetooth device and the terminal device complete a Bluetooth Low Energy (BLE) connection, incorporating, by the Bluetooth device, the first information into BLE broadcast information configured for the BLE connection, and sending, by the Bluetooth device, the BLE broadcast information to the terminal device.

In some embodiments, before the Bluetooth device sends the BLE broadcast information externally, the Bluetooth device adds the first information to the BLE broadcast information and sends the BLE broadcast information out, enabling the terminal device to receive the BLE broadcast information and obtain the GATT information of the Bluetooth device from the BLE broadcast information.

In some embodiments, the BLE broadcast information for the BLE connection may further include information related to LE Audio Bluetooth technology, thereby enabling the BLE broadcast information to further trigger the establishment of a LE Audio Bluetooth connection. For example, the BLE broadcast information may further be configured to trigger the terminal device to display a pop-up window for the user to select whether to establish a Bluetooth connection.

In an implementation, the Bluetooth device may add the first information to an idle field of the BLE broadcast information. For example, when the BLE broadcast information of the Bluetooth device contains 32 bytes, and the information originally required to be carried in the BLE broadcast information occupies 10 bytes, the Bluetooth device may append the first information to the subsequent 22 free bytes, thereby transmitting the first information via the BLE broadcast information such that the terminal device can receive it.

At block 703: receiving, by the terminal device, the BLE broadcast information sent by the Bluetooth device.

In some embodiments, the terminal device performs a Bluetooth scan and receives the BLE broadcast information sent by the Bluetooth device in the surrounding space.

At block 704: obtaining, by the terminal device, the first information based on the BLE broadcast information, and obtaining, by the terminal device, the GATT information based on the first information.

In some embodiments, the terminal device parses the BLE broadcast information to obtain the first information carried therein and obtains the GATT information of the Bluetooth device based on the first information.

At block 705: establishing, by the terminal device, the BLE connection with the Bluetooth device.

In some embodiments, after receiving the BLE broadcast information, the terminal device can establish the BLE connection with the Bluetooth device, similar to the process described in FIG. 1 above, which will not be repeated herein.

It should be noted that operations 701 to 705 may be considered as part of operations 101 to 102 in the embodiments illustrated in FIG. 1. By carrying the GATT information in the first BLE broadcast information, the Bluetooth device proactively sends the first information containing the GATT information to the terminal device before the Bluetooth device and the terminal device complete the BLE connection, which may eliminate the need for the terminal device to obtain the GATT information through an ATT query later.

It can be understood that, in some embodiments, after the GATT information is obtained, no query request is sent to the Bluetooth device to obtain the GATT information. In other words, the LE Audio Bluetooth connection can be established without going through the ATT query to obtain the GATT information, thereby enabling audio and other data transmission and communication based on LE Audio Bluetooth technology and improving the speed of the LE Audio Bluetooth connection.

In summary, the Bluetooth device obtains the first information, which includes the Bluetooth device's GATT information; before the Bluetooth device and the terminal device complete the BLE connection, the first information is sent to the terminal device such that the terminal device can obtain the GATT information based on the first information. In the present disclosure, by proactively sending the first information containing the GATT information to the terminal device before the Bluetooth device and the terminal device complete the BLE connection, the terminal device can obtain the GATT information of the Bluetooth device in advance based on the first information. After the BLE connection is established, there is no need to query the GATT information separately, thereby reducing the time required for the terminal device to obtain the GATT information and thus improving the efficiency of the terminal device in obtaining the GATT information, and further enhancing the efficiency of establishing the Bluetooth connection between the terminal device and the Bluetooth device.

In an implementation, the terminal device may establish a classic Bluetooth connection (i.e., BT connection) with the Bluetooth device before establishing the BLE connection with the Bluetooth device. The first information obtained by the Bluetooth device in FIGS. 5 to 7 may be transmitted during the process of establishing the BT connection between the Bluetooth device and the terminal device. That is, the terminal device and the Bluetooth device can simultaneously connect to both the classic Bluetooth connection and the BLE connection. The existing specifications define a Cross-transport Key Derivation (CTKD) scheme for this purpose.

The key (LTK) generated during the pairing of the BLE connection between the Bluetooth device and the terminal device and the key (linkkey) generated during the pairing of the BT connection between the Bluetooth device and the terminal device may be mutually converted. This allows the user to establish both the BT connection and BLE connection simultaneously with a single click, which is particularly important in LE Audio applications. Typically, the terminal device and the Bluetooth device first establish a BT connection, and then the CTKD automatically triggers the BLE connection between the terminal device and the Bluetooth device. This requires the Bluetooth device to support secure BT connections, and the terminal device must also support the secure BT connections.

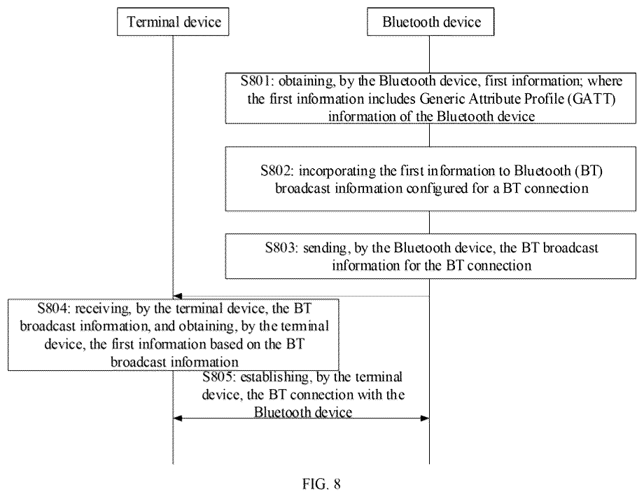

Referring to FIG. 8, FIG. 8 is a flowchart of an information acquisition method according to some embodiments of the present disclosure. The information acquisition method may be performed by a Bluetooth device and a terminal device. As shown in FIG. 8, the information acquisition method may include operations at blocks illustrated herein.

At block 801: obtaining, by the Bluetooth device, first information; where the first information includes Generic Attribute Profile (GATT) information of the Bluetooth device.

In some embodiments, the method for obtaining the first information may refer to the description in the embodiments illustrated in FIG. 7 above, which will not be repeated herein.

At block 802: incorporating, by the Bluetooth device, the first information to Bluetooth (BT) broadcast information configured for a BT connection.

During the process of establishing a classic Bluetooth connection between the terminal device and the Bluetooth device, when the Bluetooth device enters a pairing mode (e.g., Bluetooth function is turned on), the Bluetooth device transmits an Extended Inquiry Response (EIR) data packet to the surrounding space. That is, the BT broadcast information may include an EIR data packet, which may carry basic device information of the Bluetooth device (e.g., device type, device address information, device name, supported functions, etc.), and the EIR packet may include user-modifiable and customizable fields where the first information is to be added.

For example, the Bluetooth device may add a field to the EIR packet to store the first information. When the first information only contains GATT information, it is equivalent to adding the complete GATT information to the field in the EIR packet. Before the Bluetooth device and the terminal device establish the BLE connection, during the process of establishing the BT connection between the Bluetooth device and the terminal device, when the Bluetooth device sends the BT broadcast information, the Bluetooth device carries the obtained first information in the BT broadcast and sends the BT broadcast in advance to the terminal device.

At block 803: sending, by the Bluetooth device, the BT broadcast information for the BT connection to the terminal device.

At block 804: receiving, by the terminal device, the BT broadcast information, and obtaining, by the terminal device, the first information based on the BT broadcast information.

In some embodiments, the terminal device may receive the BT broadcast information sent by the Bluetooth device and parse the received BT broadcast information to obtain the first information carried therein, so as to obtain the GATT information of the Bluetooth device based on the first information. For example, the BT broadcast information includes an EIR data packet. After the terminal device receives the EIR data packet sent by the Bluetooth device, it parses and stores the EIR data packet, obtains the first information added to the EIR data packet, and thus obtains the GATT information contained in the first information.

At block 805: establishing, by the terminal device, the BT connection with the Bluetooth device.

In some embodiments, after receiving the BT broadcast information, the terminal device can establish a classic Bluetooth connection with the Bluetooth device.

In some embodiments, the classic Bluetooth connection (BT connection) may be established first, followed by the BLE connection, and then the LE Audio Bluetooth connection. This allows the GATT information to be obtained as early as possible, enabling the establishment of the final LE Audio Bluetooth connection.

It should be noted that in the above process of establishing the classic Bluetooth connection, when applying the information acquisition method provided by this scheme, the Bluetooth device and the terminal device may transmit the first information during the establishment of the classic Bluetooth connection, thus enabling the terminal device to avoid performing a separate ATT query after the subsequent BLE connection is established.

In summary, the Bluetooth device obtains the first information, which includes the Bluetooth device's GATT information; before the Bluetooth device and the terminal device complete the BLE connection, the first information is sent to the terminal device such that the terminal device can obtain the GATT information based on the first information. In the present disclosure, by proactively sending the first information containing the GATT information to the terminal device before the Bluetooth device and the terminal device complete the BLE connection, the terminal device can obtain the GATT information of the Bluetooth device in advance based on the first information. After the BLE connection is established, there is no need to query the GATT information separately, thereby reducing the time required for the terminal device to obtain the GATT information and thus improving the efficiency of the terminal device in obtaining the GATT information, and further enhancing the efficiency of establishing the Bluetooth connection between the terminal device and the Bluetooth device.

In an implementation, the first information may be added to a process of the terminal device performing a Service Discovery Protocol (SDP) query with the Bluetooth device. Specifically, after the terminal device establishes a classic Bluetooth connection with the Bluetooth device as shown in FIG. 8, the CTKD automatically triggers the BLE connection between the terminal device and the Bluetooth device. This requires the terminal device to determine whether the Bluetooth device supports a secure Bluetooth connection. When the Bluetooth device supports the secure Bluetooth connection, the terminal device may send a Service Discovery Protocol (SDP) query to the Bluetooth device, causing the Bluetooth device to return an SDP query result.

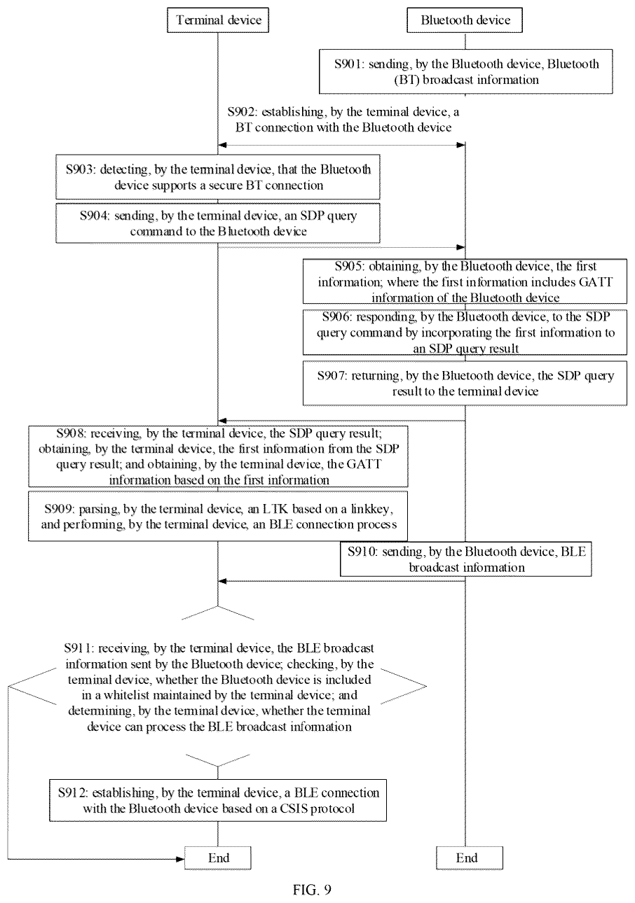

Referring to FIG. 9, FIG. 9 is a flowchart of an information acquisition method according to some embodiments of the present disclosure. The information acquisition method may be performed by a Bluetooth device and a terminal device. As shown in FIG. 9, the information acquisition method may include operations at blocks illustrated herein.

At block 901: sending, by the Bluetooth device, Bluetooth (BT) broadcast information.

At block 902: establishing, by the terminal device, a BT connection with the Bluetooth device.

At block 903: detecting, by the terminal device, that the Bluetooth device supports a secure BT connection.

In some embodiments, the method for establishing the BT connection between the terminal device and the Bluetooth device may refer to the method illustrated in FIG. 8 above, which will not be repeated herein. It should be noted that in the present embodiments, during the process of establishing the BT connection, it is not necessary to include the first information in the BT broadcast information. Instead, the first information may be added to an SDP query result when the Bluetooth device subsequently sends the SDP query result to the terminal device, thereby achieving the effect of the terminal device obtaining the GATT information of the Bluetooth device before establishing a BLE connection with the Bluetooth device.

At block 904: sending, by the terminal device, an SDP query command to the Bluetooth device.

In some embodiments, after establishing the BT connection with the Bluetooth device, the terminal device may obtain the SDP query result of the Bluetooth device by sending the SDP query command.

At block 905: obtaining, by the Bluetooth device, the first information; where the first information includes Generic Attribute Profile (GATT) information of the Bluetooth device.

In some embodiments, the method by which the Bluetooth device obtains the first information may be referenced from the description in the embodiments illustrated in FIG. 8 above, which will not be repeated herein. It should be noted that the execution process of the operation 905 may be performed after the Bluetooth device is turned on, and the present embodiments do not perform any limitation thereto. That is, the Bluetooth device may obtain the first information during the establishment of the classic Bluetooth BT connection, or may obtain the first information after the establishment of the classic Bluetooth BT connection.

At block 906: responding, by the Bluetooth device, to the SDP query command by incorporating the first information to an SDP query result.

In some embodiments, during the classic Bluetooth SDP query process, in the SDP query result sent by the Bluetooth device to the terminal device, the SDP query result further include user-modifiable and customizable fields. After receiving the SDP query command, the Bluetooth device generates the SDP query result and adds the first information to a remaining idle field in the SDP query result before sending the SDP query result to the terminal device.

At block 907: returning, by the Bluetooth device, the SDP query result to the terminal device.

The SDP query result include the added first information, i.e., the GATT information of the Bluetooth device.

At block 908: receiving, by the terminal device, the SDP query result; obtaining, by the terminal device, the first information from the SDP query result; and obtaining, by the terminal device, the GATT information based on the first information.

The terminal device receives the SDP query result sent by the Bluetooth device, parses the first information from the SDP query result, and obtains the GATT information of the Bluetooth device based on the first information.

At block 909: parsing, by the terminal device, an LTK based on a linkkey, and performing, by the terminal device, an BLE connection process.

At block 910: sending, by the Bluetooth device, BLE broadcast information.

At block 911: receiving, by the terminal device, the BLE broadcast information sent by the Bluetooth device; checking, by the terminal device, whether the Bluetooth device is included in a whitelist maintained by the terminal device; and determining, by the terminal device, whether the terminal device can process the BLE broadcast information.

The whitelist contains the names of all Bluetooth devices maintained by the terminal device. The terminal device obtains a device name of the Bluetooth device through the BLE broadcast information, determines whether the Bluetooth device is included in the whitelist maintained by the terminal device, and determines whether it can process the BLE broadcast information. When the Bluetooth device is included in the whitelist maintained by the terminal device, the terminal device can process the BLE broadcast information, proceeding to operation 912. When the Bluetooth device is not included, the process is terminated.

At block 912: establishing, by the terminal device, a BLE connection with the Bluetooth device based on a CSIS protocol.

In some embodiments, the process of establishing the BLE connection between the terminal device and the Bluetooth device in operations 909 to 912 may refer to the BLE connection establishment process described in the above embodiments, which is not repeated herein.

In an implementation, after obtaining the GATT information, the terminal device may send confirmation information to the Bluetooth device. Correspondingly, the Bluetooth device may obtain the confirmation information sent by the terminal device. For example, in the present disclosure, the Bluetooth device may further obtain the confirmation information sent by the terminal device, where the confirmation information is configured to indicate that the terminal device has obtained the GATT information; and based on the confirmation information, determine to stop sending the GATT information in the first information to the terminal device during the process of establishing the BLE connection between the Bluetooth device and the terminal device.

In other words, after the Bluetooth device sends the obtained first information, it may receive the confirmation information returned by the terminal device, thereby determining that the terminal device has already obtained the GATT information before establishing the BLE connection with the Bluetooth device. During the subsequent BLE connection establishment process, it is no longer necessary to send the GATT information to the terminal device, and the transmission of the first information in other information may be terminated. For example, when the terminal device adds the first information to the BT broadcast information and receives the confirmation information before operation 902, then the Bluetooth device may omit adding its own GATT information to the SDP query command or BLE broadcast information during subsequent SDP query processes and BLE broadcast information transmission, thereby reducing data transmission volume and improving connection efficiency. Alternatively, when the terminal device adds the first information to the SDP query result and receives the confirmation information before operation 909, the Bluetooth device may omit adding the GATT information to the BLE broadcast information during subsequent BLE broadcast information transmission, thereby reducing data transmission volume and improving connection efficiency.

In some embodiments, when sending the confirmation information, the terminal device may directly send the confirmation information to the Bluetooth device, such as the terminal device directly sending the confirmation information to the Bluetooth device. Alternatively, the terminal device may carry the confirmation information in information to be sent to the Bluetooth device, such as the confirmation information being carried in second information sent by the terminal device to the Bluetooth device, where the second information is query information sent by the terminal device to the Bluetooth device.

For example, the Bluetooth device receives the query information sent by the terminal device, which includes the confirmation information; based on the query information, the confirmation information is obtained. For example, the Bluetooth device adds the first information during the BT broadcast process. After the terminal device obtains the GATT information, the terminal device may add the confirmation information to the SDP query command during the SDP query process, specifically when sending the SDP query command at operation 904. Correspondingly, after receiving the SDP query command, the Bluetooth device parses it to obtain the confirmation information carried in the SDP query command.

It should be noted that the method by which the terminal device feeds back the confirmation information may be flexibly adjusted. After receiving the GATT information, the terminal device may no longer need to interact with the Bluetooth device for further information exchange. The terminal device may directly send the confirmation information to the Bluetooth device. When the terminal device needs to interact with the Bluetooth device again (e.g., to perform an SDP query process), the terminal device may include the confirmation information in the information to be sent to the Bluetooth device. The feedback method of the confirmation information may be applied to the various embodiments illustrated in FIGS. 5 to 8.

Additionally, in the embodiments illustrated in FIGS. 5 to 9, after receiving the first information, the Bluetooth device may choose to carry the first information in any one or combination of the BT broadcast information, the BLE broadcast information, and the SDP query command, depending on the developer's requirements. As long as the Bluetooth device sends its GATT information to the terminal device before the BLE connection is established, the present disclosure is not limited to any specific method.

It can be understood that, in some embodiments, after obtaining the GATT information, the terminal device no longer sends a query request to the Bluetooth device to obtain the GATT information. In other words, the LE Audio Bluetooth connection may be established without going through the ATT query to obtain the GATT information, thereby enabling audio and other data transmission and communication based on LE Audio Bluetooth technology and thus improving the speed of the LE Audio Bluetooth connection.

In the above embodiments, the Bluetooth device is exemplified as a Bluetooth headset (TWS headset). In actual applications, the Bluetooth device may be other product forms (e.g., smart bracelets, smart watches, TWS speakers, etc.) or include multiple Bluetooth devices and combinations thereof. The specific Bluetooth device is not limited herein.

It should be noted that, in the embodiments of establishing the Bluetooth connection illustrated in FIGS. 5 to 9, after the Bluetooth device and the terminal device complete the BLE connection, the Bluetooth device further completes the LE Audio Bluetooth connection with the terminal device based on the LE Audio protocol. Since the Bluetooth device transmits its GATT information and corresponding handle identifier to the terminal device via the BLE broadcast, and/or classic EIR packet, and/or SDP query result, the terminal device may omit a process of querying the GATT information (service discovery process) one by one after establishing the BLE connection as shown in FIG. 1, thereby saving connection time and improving the efficiency of establishing the LE Audio Bluetooth connection between the Bluetooth devices and the terminal device. Taking a mobile phone and a headset as an example, the mobile phone and the headset bypass the standard GATT service discovery process, by the headset's GATT structure and corresponding handle identifier being synchronized to the mobile phone via BLE broadcast content, classic EIR packets, or SDP. Subsequently, the mobile phone may omit the service discovery process, thereby saving connection time and enhancing the user experience.

In summary, the Bluetooth device obtains the first information, which includes the Bluetooth device's GATT information; before the Bluetooth device and the terminal device complete the BLE connection, the first information is sent to the terminal device such that the terminal device can obtain the GATT information based on the first information. In the present disclosure, by proactively sending the first information containing the GATT information to the terminal device before the Bluetooth device and the terminal device complete the BLE connection, the terminal device can obtain the GATT information of the Bluetooth device in advance based on the first information. After the BLE connection is established, there is no need to query the GATT information separately, i.e., the process of querying the GATT information may be omitted compared to the scheme illustrated in FIG. 1, thereby reducing the time required for the terminal device to obtain the GATT information and thus improving the efficiency of the terminal device in obtaining the GATT information, and further enhancing the efficiency of establishing the Bluetooth connection between the terminal device and the Bluetooth device.

Additionally, in the present scheme, feedback confirmation information is exchanged between the terminal device and the Bluetooth device to promptly cancel any redundant transmission of GATT information, thereby further improving the efficiency of establishing BLE connections.

The following describes an information acquisition apparatus, which may be configured to implement the method embodiments disclosed herein. For details not disclosed in the apparatus embodiments herein, reference may be made to the method embodiments as above.

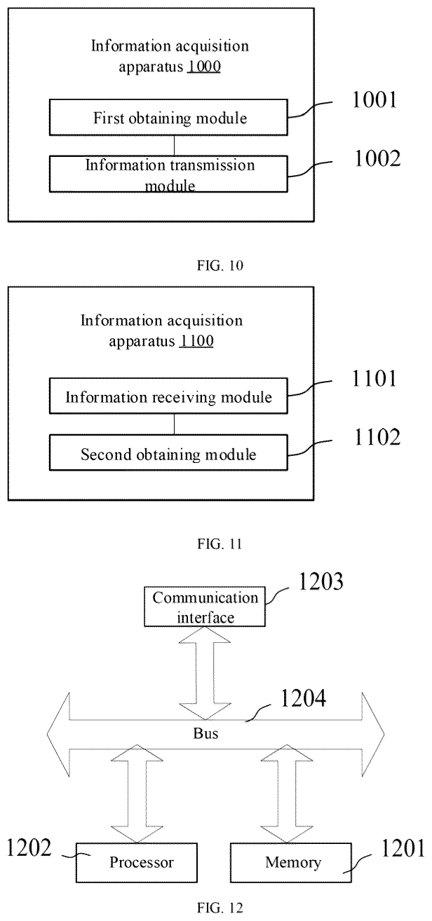

Referring to FIG. 10, FIG. 10 is a structural block diagram of an information acquisition apparatus according to some embodiments of the present disclosure. The information acquisition apparatus 1000 may be performed by a Bluetooth device to perform all or part of the operations in the method performed by the Bluetooth device provided by the embodiments illustrated in FIG. 5, 7, 8, or 9. The information acquisition apparatus 1000 includes components as followed.

A first obtaining module 1001, configured to obtain first information; where the first information includes Generic Attribute Profile (GATT) information of the Bluetooth device.

An information transmission module 1002, configured to send the first information to the terminal device before the Bluetooth device and a terminal device complete a Bluetooth Low Energy (BLE) connection, for enabling the terminal device to obtain the GATT information based on the first information.

In summary, the Bluetooth device obtains the first information, which includes the Bluetooth device's GATT information; before the Bluetooth device and the terminal device complete the BLE connection, the first information is sent to the terminal device such that the terminal device can obtain the GATT information based on the first information. In the present disclosure, by proactively sending the first information containing the GATT information to the terminal device before the Bluetooth device and the terminal device complete the BLE connection, the terminal device can obtain the GATT information of the Bluetooth device in advance based on the first information. After the BLE connection is established, there is no need to query the GATT information separately, thereby reducing the time required for the terminal device to obtain the GATT information and thus improving the efficiency of the terminal device in obtaining the GATT information, and further enhancing the efficiency of establishing the Bluetooth connection between the terminal device and the Bluetooth device.

In some embodiments, the information transmission module 1002 includes: a first sending unit.

The first sending unit is configured to incorporate the first information into BLE broadcast information configured for the BLE connection and send the BLE broadcast information to the terminal device.

In some embodiments, the apparatus further includes: a first establishment module, configured to establish a Bluetooth (BT) connection with the terminal device before establishing the BLE connection.

The information transmission module 1002 includes: a second sending unit.

The second sending unit is configured to incorporate the first information to BT broadcast information configured for the BT connection and send the BT broadcast information to the terminal device.

In some embodiments, the apparatus further includes: a first receiving module, configured to receive a Service Discovery Protocol (SDP) query command sent by the terminal device.

The information transmission module 1002 includes: a third sending unit.

The third sending unit is configured to respond to the SDP query command by incorporating the first information to an SDP query result, and send the SDP query result to the terminal device.

In some embodiments, the GATT information includes one or more management handle identifiers corresponding to information units.

In some embodiments, the apparatus further includes components as followed.

A first acquisition module, configured to obtain confirmation information sent by the terminal device after sending the first information to the terminal device; where the confirmation information indicates that the terminal device has received the GATT information.

A first determination module, configured to determine, based on the confirmation information, to stop sending the GATT information in the first information to the terminal device during the process of establishing the BLE connection between the Bluetooth device and the terminal device.

In some embodiments, the first acquisition module includes: a first receiving unit and a first acquisition unit.

The first receiving unit is configured to receive query information sent by the terminal device, where the query information includes the confirmation information.

The first acquisition unit is configured to obtain the confirmation information based on the query information.

In some embodiments, the apparatus further includes: a second establishment module, configured to establish a LE Audio Bluetooth connection with the terminal device based on an LE Audio protocol after the Bluetooth device and the terminal device have completed the BLE connection.

Referring to FIG. 11, FIG. 11 is a structural block diagram of an information acquisition apparatus according to some embodiments of the present disclosure. The information apparatus device 1100 may be performed by a terminal device to perform all or part of the operations in the method performed by the terminal device provided by the embodiments illustrated in FIG. 5, 7, 8, or 9. The information acquisition apparatus 1100 includes components as followed.

An information receiving module 1101, configured to receive first information sent by a Bluetooth device before the terminal device and the Bluetooth device complete a Bluetooth Low Energy (BLE) connection; where the first information includes Generic Attribute Profile (GATT) information of the Bluetooth device.

A second obtaining module 1102, configured to obtain the GATT information based on the first information.

In summary, the Bluetooth device obtains the first information, which includes the Bluetooth device's GATT information; before the Bluetooth device and the terminal device complete the BLE connection, the first information is sent to the terminal device such that the terminal device can obtain the GATT information based on the first information. In the present disclosure, by proactively sending the first information containing the GATT information to the terminal device before the Bluetooth device and the terminal device complete the BLE connection, the terminal device can obtain the GATT information of the Bluetooth device in advance based on the first information. After the BLE connection is established, there is no need to query the GATT information separately, thereby reducing the time required for the terminal device to obtain the GATT information and thus improving the efficiency of the terminal device in obtaining the GATT information, and further enhancing the efficiency of establishing the Bluetooth connection between the terminal device and the Bluetooth device.

In some embodiments, the information receiving module 1101 is configured to receive BLE broadcast information sent by the Bluetooth device configured for the BLE connection, where the BLE broadcast information includes the first information; and to obtain the first information based on the BLE broadcast information.

In some embodiments, the apparatus further includes components as followed.

A third establishment module, configured to establish a Bluetooth (BT) connection with the Bluetooth device before establishing the BLE connection.

The information receiving module 1101 is further configured to receive BT broadcast information sent by the Bluetooth device configured for a BT connection, where the BT broadcast information includes the first information; and to obtain the first information based on the BT broadcast information.

In some embodiments, the apparatus further includes: a command sending module, configured to send a Service Discovery Protocol (SDP) query command to the Bluetooth device.

The information receiving module 1101 is further configured to receive an SDP query result sent by the Bluetooth device, where the SDP query result includes the first information; and obtain the first information based on the SDP query result.

In some embodiments, the GATT information includes one or more management handle identifiers corresponding to information units.

In some embodiments, the apparatus further includes: a second transmission module, configured to send confirmation information to the Bluetooth device after obtaining the GATT information based on the first information, where the confirmation information indicates that the terminal device has obtained the GATT information.

In some embodiments, the confirmation information is carried in second information sent by the terminal device to the Bluetooth device, where the second information is query information sent by the terminal device to the Bluetooth device.

In some embodiments, the second transmission module is further configured not to send a query request for obtaining GATT information to the Bluetooth device after confirming the acquisition of the GATT information.

In some embodiments, the apparatus further includes: a fourth establishment module, configured to establish a LE Audio Bluetooth connection with the Bluetooth device based on an LE Audio protocol after the terminal device and the Bluetooth device have completed the BLE connection.

Referring to FIG. 12, FIG. 12 is a structural diagram of a Bluetooth device according to some embodiments of the present disclosure. The Bluetooth device 1200 includes: a processor 1201, a memory 1202, a communication interface 1203, and a bus 1204. The memory 1202 is configured to store instructions, and the processor 1201 is configured to execute the instructions stored in the memory 1202. The processor 1201, the memory 1202, and the communication interface 1203 are interconnected via the bus 1204 to enable communication between them.

The Bluetooth device 1200 may be configured to perform the various operations and/or processes in the method embodiments performed by the Bluetooth device as described above.

In some embodiments, the memory 1202 may include read-only memory and random-access memory, to provide the instructions and data to the processor 1201. A portion of the memory 1202 may include non-volatile random-access memory. For example, the memory 1202 may further store information about device types. The processor 1201 may be configured to execute the instructions stored in the memory, and when executing such instructions, the processor 1201 may perform the various operations and/or processes in the method embodiments performed by the Bluetooth device as described above.

It should be understood that, in the embodiments of the present disclosure, the processor may be a central processing unit (CPU), and the processor may be other general-purpose processors, digital signal processors (DSPs), application-specific integrated circuits (ASICs), field-programmable gate arrays (FPGAs), or other programmable logic devices, discrete gates or transistor logic devices, discrete hardware components, etc. The general-purpose processor may be a microprocessor or any conventional processor, etc.

The present disclosure further provides a Bluetooth device including a processor and a memory, where the memory stores at least one instruction, at least one program, a code set, or an instruction set, and the at least one instruction, the at least one program, the code set, or the instruction set is loaded and executed by the processor to implement all or part of the operations performed by the terminal device or the Bluetooth device in the information acquisition method described in the above embodiments.

The present disclosure further provides a terminal device including a processor and a memory, where the memory stores at least one instruction, at least one program, a code set, or an instruction set, and the at least one instruction, the at least one program, the code set, or the instruction set is loaded and executed by the processor to implement all or part of the operations performed by the terminal device or the Bluetooth device in the information acquisition method described in the above embodiments.

The present disclosure further provides a computer-readable medium, where the storage medium stores at least one instruction, at least one program, a code set, or an instruction set, and the at least one instruction, the at least one program, the code set, or the instruction set is loaded and executed by a processor to implement all or part of the operations performed by the terminal device or the Bluetooth device in the information acquisition method described in the above embodiments.

The present disclosure further provides a computer program product, the computer program product storing at least one instruction, the at least one instruction being loaded and executed by a processor to implement all or part of the operations performed by the terminal device or the Bluetooth device in the information acquisition method described in the above embodiments.

The embodiments of the present disclosure further provide an application publishing platform, where the application publishing platform is configured to publish a computer program product. When the computer program product is executed on a computer, the computer is caused to execute all or part of the operations performed by the terminal device or the Bluetooth device in the information acquisition method described in the above embodiments.

It should be noted that: the apparatus provided in the above embodiments, when executing the control of the terminal device, is only illustrated by the division of the above functional modules. In actual application, the above functions may be distributed to different functional modules as needed, i.e., the internal structure of the apparatus may be divided into different functional modules to perform all or part of the functions described above. Additionally, the apparatus and method embodiments provided in the above embodiments belong to the same conceptual framework, and their specific implementation processes are detailed in the method embodiments, which are not repeated herein.

Any embodiment number in the present disclosure is solely for descriptive purposes and does not indicate the relative merits of the embodiments. In case of conflicts, the above embodiments, implementation methods, and related technical features may be combined with one another.

Those skilled in the art will understand that the entire or part of the operations of the above embodiments may be implemented using hardware, or by instructing related hardware through a program. The program may be stored in a computer-readable storage medium, which may include a read-only memory, a disk, or an optical disk, among others.

The above description is merely some embodiments of the present disclosure and is not intended to limit the scope of the present disclosure. Any modifications, equivalent replacements, improvements, etc., made within the spirit and principles of the present disclosure should be included within the scope of the present disclosure.

1. An information acquisition method, performed by a Bluetooth device and comprising:
obtaining first information: wherein the first information comprises Generic Attribute Profile (GATT) information of the Bluetooth device; and
sending the first information to a terminal device to enable the terminal device to obtain the GATT information based on the first information, before the Bluetooth device and the terminal device complete a Bluetooth Low Energy (BLE) connection.

2. The method according to claim 1, wherein the sending the first information to a terminal device comprises:
incorporating the first information into BLE broadcast information configured for the BLE connection, and sending the BLE broadcast information to the terminal device.

3. The method according, to claim 1, before the BLE connection is established, further comprising:
establishing a Bluetooth (BT) connection with the terminal device:
wherein the sending the first information to a terminal device comprises:
incorporating the first information to BT broadcast information configured for the BT connection, and sending the BT broadcast information to the terminal device.

4. The method according to claim 1, before the BLE connection is established, further comprising:
establishing a Bluetooth (BT) connection with the terminal device; and
receiving a Service Discovery Protocol (SDP) query command sent by the terminal device;
wherein the sending the first information to a terminal device comprises:
responding to the SDP query command by incorporating the first information to an SDP query result, and sending the SDP query result to the terminal device.

5. The method according to claim 1, wherein the GATT information comprises one or more management handle identifiers corresponding to information units.

6. The method according to claim 1, after the sending the first information to a terminal device, further comprising:
obtaining confirmation information sent by the terminal device; wherein the confirmation information is configured to indicate that the terminal device has received the GATT information;
based on the confirmation information, determining to stop sending the GATT information in the first information to the terminal device during a process of establishing the BLE connection between the Bluetooth device and the terminal device.

7. The method according to claim 6, wherein the obtaining confirmation information sent by the terminal device comprises:
receiving query information sent by the terminal device; wherein the query information comprises the confirmation information; and
obtaining the confirmation information based on the query information.

8. The method according to claim 1, after the Bluetooth device and the terminal device complete the BLE connection, further comprising:
establishing a Low Energy (LE) Audio Bluetooth connection with the terminal device based on an LE Audio protocol.

9. An information acquisition method, performed by a terminal device and comprising:
receiving first information sent by a Bluetooth device before the terminal device and the Bluetooth device complete a Bluetooth Low Energy (BLE) connection; wherein the first information comprises Generic Attribute Profile (GATT) information of the Bluetooth device; and
obtaining the GATT information based on the first information.

10. The method according to claim 9, wherein the receiving first information sent by a Bluetooth device comprises:
receiving BLE broadcast information sent by the Bluetooth device configured for the BLE connection; wherein the BLE broadcast information comprises the first information; and
obtaining the first information based on the BLE broadcast information.

11. The method according to claim 9, before the BLE connection is established, further comprising:
establishing a Bluetooth (BT) connection with the Bluetooth device:
wherein the receiving first information sent by a Bluetooth device comprises:
receiving BT broadcast information sent by the Bluetooth device configured for the BT connection; wherein the BT broadcast information comprises the first information; and
obtaining the first information based on the BT broadcast information.

12. The method according to claim 9, before the BLE connection is established, further comprising:
establishing a Bluetooth (BT) connection with the Bluetooth device; and
sending a Service Discovery Protocol (SDP) query command to the Bluetooth device;
wherein the receiving first information sent by a Bluetooth device comprises:
receiving an SDP query result sent by the Bluetooth device: wherein the SDP query result comprises the first information; and
obtaining the first information based on the SDP query result.

13. The method according to claim 9, wherein the GATT information comprises one or more management handle identifiers corresponding to information units.

14. The method according to claim 9, after the obtaining the GATT information based on the first information, further comprising:
sending, confirmation information to the Bluetooth device; wherein the confirmation information is configured to indicate that the terminal device has received the GATT information.

15. The method according to claim 9, further comprising:
not sending a query request for obtaining the GATT information to the Bluetooth device after confirming an acquisition of the GATT information.

16. The method according to claim 9, after the Bluetooth device and the terminal device complete the BLE connection, further comprising:
establishing a Low Energy (LE) Audio Bluetooth connection with the Bluetooth device based on an LE Audio protocol.

17-19. (canceled)

20. A terminal device, comprising a processor and a memory; wherein the memory stores one kind of: at least one instruction, at least one program, a code set, and an instruction set, and the one kind of the at least one instruction, the at least one program, the code set, and the instruction set is configured to be loaded and executed by the processor to implement the method according to claim 9.

21. (canceled)

22. The method according to claim 2, wherein the incorporating the first information into BLE broadcast information configured for the BLE connection comprises:
incorporating the first information into an idle field of the BLE broadcast information.

23. The method according to claim 12, after the obtaining the first information based on the SDP query result, further comprising:
receiving BLE broadcast information sent by the Bluetooth device configured for the BLE connection; checking whether the Bluetooth device is included in a whitelist maintained by the terminal device; and determining whether the terminal device is capable of processing the BLE broadcast information; and
establishing the BLE connection with the Bluetooth device based on a CSIS protocol.

24. The method according to claim 1, wherein a structure of the GATT information comprises at least one of: a service unit, a characteristic unit, a measurement unit, a description unit, and a physical characteristic unit.
